(19) United States
(12) Patent Application Publication
(10) Pub. No.: US 2023/0165261 A1
(43) Pub. Date: Jun. 1, 2023

(54) METHODS AND COMPOSITIONS RELATED TO GUT TRANSIT MEASUREMENT

(71) Applicant: University of Miami, Miami, FL (US)

(72) Inventors: Julia Dallman, Miami, FL (US); Baharak Moshiree, Miami, FL (US)

(21) Appl. No.: 18/059,601

(22) Filed: Nov. 29, 2022

Related U.S. Application Data
(60) Provisional application No. 63/283,665, filed on Nov. 29, 2021.

(51) Int. Cl. A21D 13/066; A21D 13/40

(52) U.S. Cl. CPC A21D 13/066; A21D 13/40

(57) ABSTRACT

Disclosed herein are methods and compositions related to determining gut transit time. The composition comprises a blue dye, which can be used to measure transit time from consumption to elimination as a waste product.

### CROSS-REFERENCE TO RELATED APPLICATIONS

This application claims benefit of U.S. Provisional Application No. 63/283,665, filed Nov. 29, 2021, incorporated herein by reference in its entirety.

### BACKGROUND

Diagnosis of upper gastrointestinal (GI) motility disorders is currently done by three validated measures quantifying the degree of delay in gastric emptying: liquid and solid scintigraphy, wireless motility capsule, and breath testing by either C-Octanoic acid or C-Spirulina plantensis algae which has recently been approved by the Food and Drug Administration (FDA).

For gastric scintigraphy done by nuclear medicine, a standardized method using a solid meal with posterior and anterior scanning extended to four hours is advocated given the increased sensitivity and specificity as compared to two hour testing. Whole gut scintigraphy is also done to measure whole gut motility and transit using radioisotopes in the radiology nuclear medicine departments. However the use of nuclear medicine scintigraphy for the entire gut exposes patients to radiation and involves costly radioactive materials. In addition, this standardized protocol is adhered to by few radiology programs as it requires multiple imaging over many days requiring oftentimes that the patient have multiple scans. The normal gastric transit method uses a standard meal for gastric scintigraphy uses an egg meal with 2 pieces of bread as well as jam and butter. This meals equals 256 calories total and is conducted similarly around the country as a means to maintain the same amount of fiber, protein and fat. Using gastric emptying scintigraphy for solids, a gastric emptying study showing over 10% meal retention at 4 hours then suggests upper gastrointestinal symptoms may be due to gastroparesis. Despite this national standard, many institutions still have not adopted the four-hour scanning; shorter testing could potentially underestimate the true prevalence of GP in clinical practice. In one study 26% of non-diabetic patients presenting to the Nuclear Medicine Department at Temple University for evaluation of dyspeptic symptoms were found to have normal solid emptying but delayed liquid emptying, as assessed using 120 ml of water radiolabled with In-111 diethylene triamine pentacetic acid.

As an alternative, the wireless motility capsule (SmartPill Corp., Buffalo, N.Y., USA) has recently been validated as a diagnostic tool providing a measure of the gastric emptying time, motility index, and pH in the gut lumen, with a sensitivity for GP of 65% and specificity 87% at the 300-minute cut off. Unfortunately wireless motility capsule cannot be done in any patients less than 18 years of age. This technology has not been FDA approved in this age group. In addition there is a risk of capsule retention which would then necessitate surgery in a subset of patients. Therefore in patients who have symptoms of swallowing disorder such as dysphagia or any evidence of prior history of small bowel obstruction or strictures, this procedure and technique is contraindicated. The meal ingested with a wireless motility capsule is a smartbar which has gluten that many patients with GI distress cannot ingest.

A technique that is validated and FDA approved in children is gastric emptying breath test. This test involves ingestion of a carbon 13-labeled meal much like the meal given with the scintigraphy. Measurements include the rate of gastric emptying that is measured from breath samples obtained over a 3-hour timeframe. The components of the meal are similar to what is used in the gastric scintigraphy but, in addition include Spirulina as the source of the carbon 13 isotope. This type of assessment of transit through the stomach is done mainly for the purposes of clinical trials however, and is not an assessment of entire gut motility (meaning small bowel or colon).

What is needed in the art is an easy, affordable method that children and adults could get evaluation for their entire gut transit through swallowing of a proportioned blue dye food that can then be detected in the stool once patient has a bowel movement.

### SUMMARY

Disclosed herein is a composition for measuring gut transit time, the composition comprising: 3 egg whites from large eggs (100 mL/99 grams); ½ teaspoon cream of tartar; 1 tablespoon sugar; 2 tablespoons jam (can be any flavor, preferably fruit jam, one example is seedless raspberry jam); 2 tablespoons of Gluten-Free Flour (one example is King Arthur Brand); 1½ teaspoons soy or whey protein (depending on patient's allergies); and 1 teaspoon blue food coloring.

Also disclosed herein is a method of baking the composition, the method comprising pre-heating the oven to 350° F., beating egg whites with cream of tartar and sugar for 1 minute or until soft peaks form; add jam and continue to beat for 30 seconds; add flour 1 tablespoon at a time and beat for a full minute after each addition; add protein powder and beat until incorporated; pouring into oven-safe container; cook 30 minutes or until kitchen thermometer reads at least 206° F.

The method and composition disclosed herein can be used to measure whole gut transit time and mimics the meal that is currently used for gastric emptying scintigraphy. This method can be administered by feeding to a subject the composition disclosed herein, and determining when the composition has been eliminated as waste by monitoring the subject's stool until blue color is seen.

Further disclosed is a kit comprising two or more of the components of the composition. The kit can further include instructions. The kit provides an objective measure of whole gut transit and is intended for use with an app that helps determine the time taken to ingest the product, the portion consumed, and the time to first and last blue bowel movement (known as lag phase). The objective measure of whole gut transit is then integrated with other symptoms that families are tracking, with the ultimate goal of more effective, evidence-based symptom management.

### BRIEF DESCRIPTION OF FIGURES

FIG. 1 shows a graph of transit times in patients, and corresponds to Table 3.

FIG. 2A-B shows blue cake before and after baking.

FIG. 3 shows average time from ingestion to stooling, as measured by blue cakes.

FIG. 4A-E shows (A) process of obtaining information and measuring transit time; (B) transit time measurements; (C) distribution of the four transit time classes; (D) Bristol stool types; and (E) bowel movements.

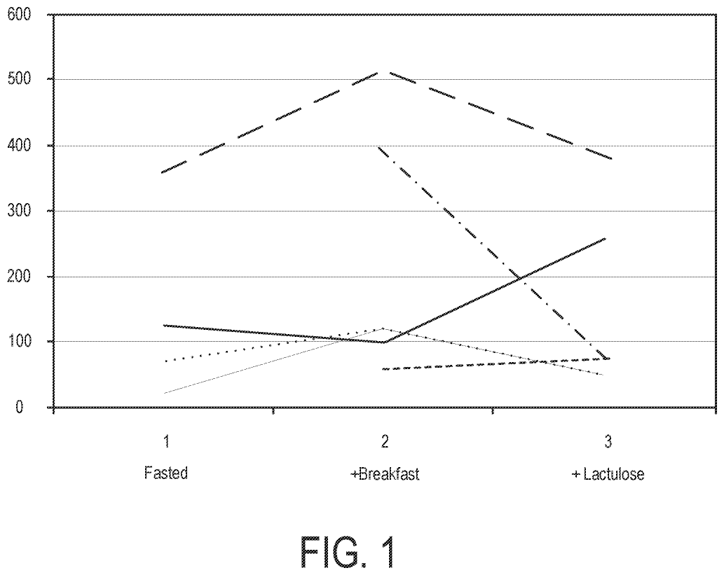

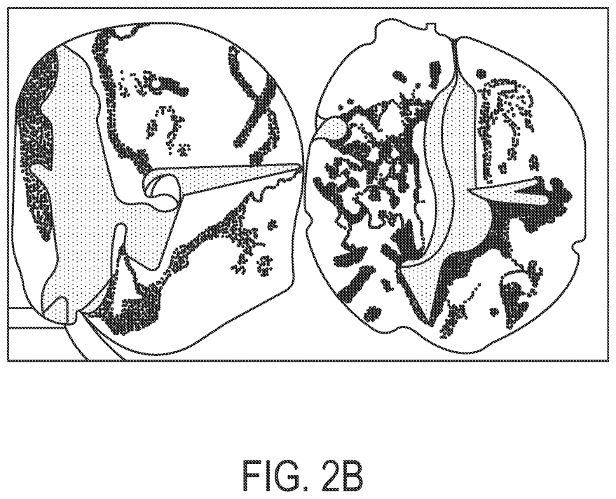

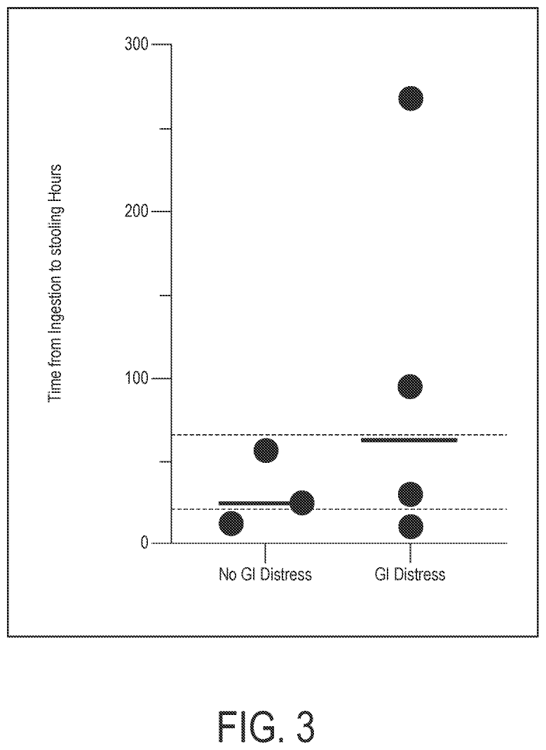

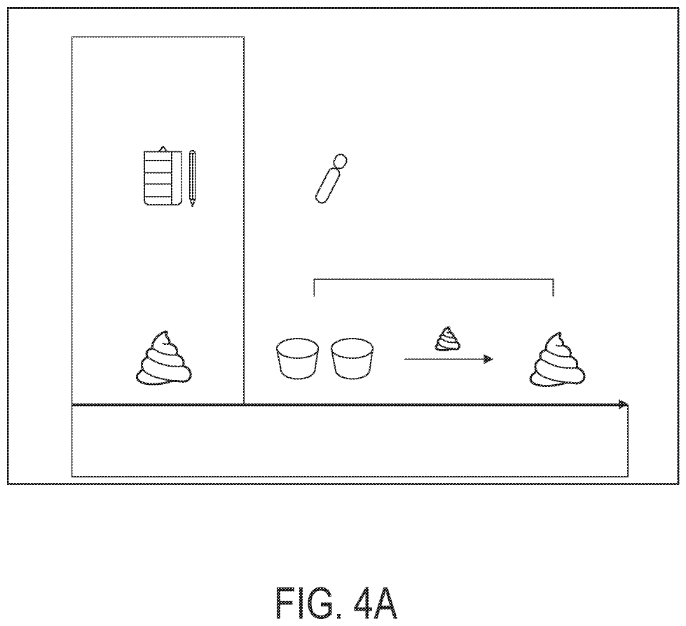

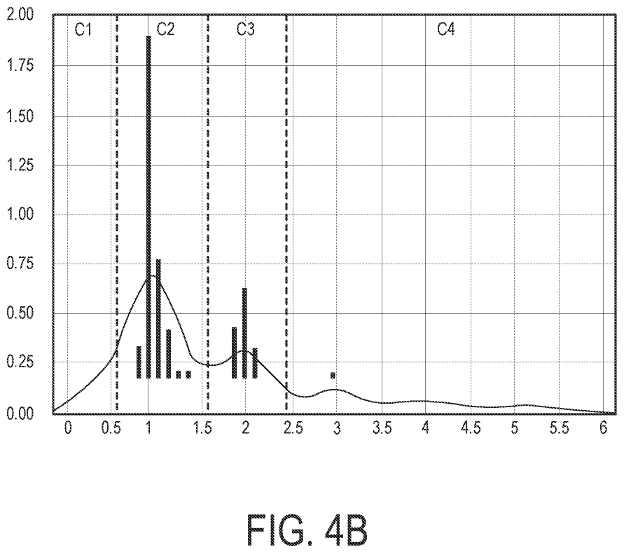

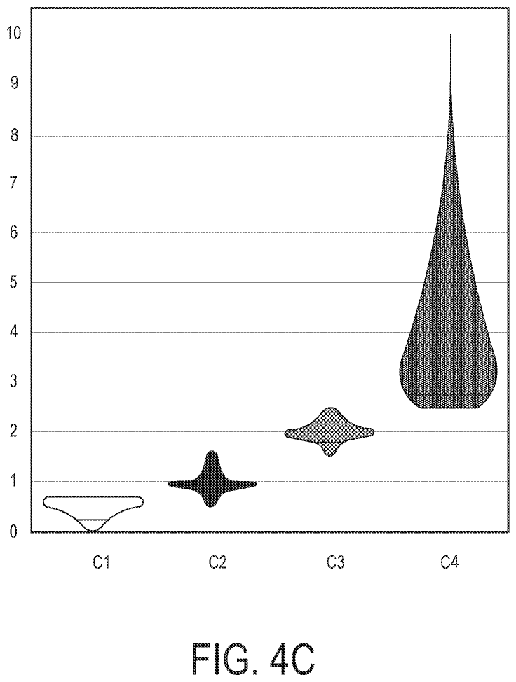

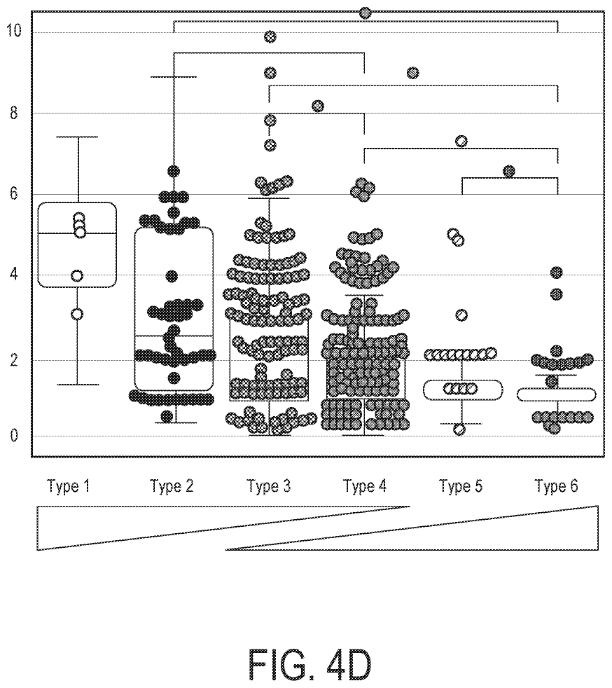

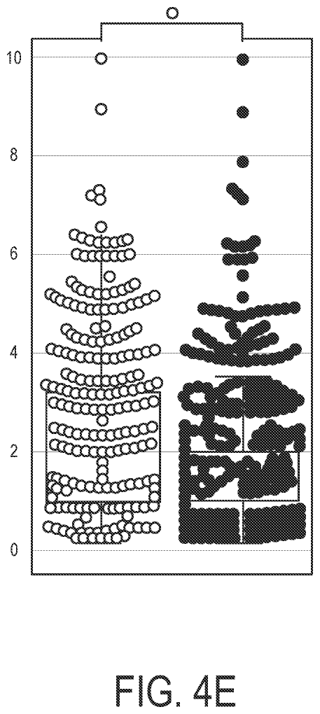

### DETAILED DESCRIPTION

The disclosed composition and method is a straightforward approach that allow for the evaluation of both children and adults for their entire gut transit. This is done by swallowing of 2 blue dye muffin meals that can then be detected in the stool once patient has a bowel movement. This new technique is more easily ingested by patients who have GI motility disorders with symptoms of abdominal pain, nausea, vomiting, diarrhea or constipation. This is derived from the study done in patients who had short gut syndrome and who were given this diet meal to evaluate the gut transit through the ostomies. This new technique can be done in both pediatrics and adults, and does not lead to capsule retention, and has the added advantage of not exposing patients to radioactive material.

The disclosed “blue muffin meal” mechanism for studying gut transit avoids the high cost of testing, is a more tasty option for patients with disturbed gut health and for healthy subjects and allows for mass production in several facilities around the country. These methods are compared below in Table 1.

TABLE 1
Methods of Determining Gut Transit Time

| Test | Method | Limitations |
|---|---|---|
| Radiology | Plain x ray | Radiation exposure |
| | Barium with small bowel | For Cine-MRI - |
| | follow through (SBFT) | Validation of clinical |
| | Computerized tomography | utility pending |
| | (CT)-CTE | (Cost?0 |
| | Cine-MRI | |
| | *Whole gut scintigraphy | |
| | *only Scintigraphy is | |
| | validated for whole gut | |
| | transit | |
| Conventional/ | Multi-lumen catheter | Low specificity and |
| High | (Water perfused or solid | invasive |
| Resolution | state) | Not standardized |
| Manometry | Determines if neurogenic | Requires trained |
| | or myogenic | expertise in motility |
| | Can determine obstruction | Poor correlation with |
| | from motility disorder | histopathology |
| | | Picks up artifacts |
| | | (cardiac or pulmonary) |
| | | High cost |
| Wireless motility | Determines intraluminal | Risk of capsule |
| capsule | pressure and pH (transit) - | retention |
| | Whole gut transit and small | Contraindicated if |
| | bowel transit | Crohns or hx |
| | 15%-30% of patients with | obstruction or |
| | gastroparesis have colonic | dysphagia |
| | transit or small bowel | High Cost |
| | transit abnormalities | |
| Breath testing | Not validated for colonic | Not gold standard |
| | transit FDA approved in | |
| | Children for gastric transit | |
| | only. | |
| Radioopaque | Not validated for stomach | Radiation exposure and |
| markers | or small bowel transit | not valid for stomach or |
| | | bowel transit |
| Histopathology | Full thickness small bowel | London Classification |
| | biopsy, stomach or colon | only. No clinical |
| | biopsy is invasive and has | consensus reached but |
| | to be done surgically | evolving technique (can |
| | | differentiate myopathy, |
| | | neuropathy, from loss of |
| | | ganglion or decrease |
| | | and ICC loss) |
| | | Invasive |

Disclosed herein is a composition for measuring gut transit time, the composition comprising: 3 egg whites from large eggs (100 mL/99 grams); ½ teaspoon cream of tartar; 1 tablespoon sugar; 2 tablespoons jam (can be any flavor, preferably fruit jam, one example is seedless raspberry jam); 2 tablespoons of Gluten-Free Flour (one example is King Arthur Brand); 1½ teaspoons soy or whey protein; and 1 teaspoon blue food coloring. This composition can be referred to as “blue muffins.”

The composition disclosed herein can be made using the following method: pre-heating the oven to 350° F., beating egg whites with cream of tartar and sugar for 1 minute or until soft peaks form; add jam and continue to beat for 30 seconds; add flour 1 tablespoon at a time and beat for a full minute after each addition; add protein powder and beat until incorporated; pouring into oven-safe container; cook 30 minutes or until kitchen thermometer reads at least 206° F.

It is noted that 1 teaspoon of blue food coloring (also referred to herein as dye) is a significantly higher amount than that found in typical recipes for an added food coloring. It is surprising and unexpected that one can best determine transit time using this amount of food coloring.

The method and composition disclosed herein can be used to measure gut transit time. This method can comprise administering by feeding to a subject the composition disclosed herein, and determining when the composition has been eliminated as waste by monitoring the subject's stool until first blue color is seen (whole gut transit) and all subsequent blue stools (lag phase). Whole gut transit can help to determine if the subject is suffering from gastroparesis, for example while lag phase provides a measure of whole gut emptying. It is noted that the composition disclosed herein is not inflammatory and can be used as part of a “gastroparesis diet.”

Gastroparesis is a condition that affects the normal spontaneous movement of the muscles (motility) in the stomach. Ordinarily, strong muscular contractions propel food through your digestive tract. But with gastroparesis, this movement is slowed down or doesn't work at all, preventing proper emptying and leading to symptoms such as nausea, vomiting, stomach pain, distension and fullness with bloating and constipation.

Gastroparesis can be caused by diabetes. It can also be present in a subject after surgery or due to vital illnesses. Certain medications, such as opioid pain relievers, some antidepressants, and high blood pressure and allergy medications, can lead to slow gastric emptying and cause similar symptoms. Diabetes is another common cause of gastroparesis. Gastroparesis may also be linked to gastrointestinal distress common in Autism Spectrum Disorders.

Gastroparesis can interfere with normal digestion, cause nausea, vomiting, abdominal pain and constipation. It can also cause problems with blood sugar levels and nutrition.

TABLE 2
NUTRITIONAL COMPONENTS OF BLUE MUFFINS

| | Egg | | | | Protein | | |
|---|---|---|---|---|---|---|---|
| | white | Sugar | Jam | Flour | powder | Butter/oils | Totals |
| Carbs | | 45 | 100 | 38.7 | | | 183.7 |
| Protein | 51 | | | 1.6 | 10 | | 62.6 |
| Fat | | | | | | 5.1 | 5.1 |
| Fiber | | | | 3.2 | | | 3.2 |
| Total | | | | | | | 254.6 |

TABLE 3
BLUE MARKER TRANSIT TIME IN MINUTES

| | | Blue Marker | Blue Marker |
|---|---|---|---|
| | Blue Marker | (fasted + | (fasted + |
| Patient | (fasted) | breakfast) | lactulose) |
| 1 | ND | 53 | 60 |
| | ND | 50 | ND |
| 2 | ND | 60 | 70 |
| | ND | ND | ND |
| 3 | 70 | 175 | 65 |
| | 70 | 60 | 30 |
| 4 | 10 | 50 | 65 |
| | 30 | 180 | 10 |
| 5 | 35 | 125 | 75 |
| | 210 | 60 | 430 |
| 6 | 320 | NS | 535 |
| | 406 | 513 | 250 |
| 7 | ND | NS | NS |
| | ND | NS | ND |
| 8 | ND | 1685 | NS |
| | ND | 720 | NS |

ND: not done; NS: not seen.
Note that patients 1, 2, 7, and 8 did not participate in the study with blue marker fasted.

It will be apparent to those skilled in the art that various modifications and variations can be made in the present disclosure without departing from the scope or spirit of the invention. Other embodiments of the disclosure will be apparent to those skilled in the art from consideration of the specification and practice of the methods disclosed herein. It is intended that the specification and examples be considered as exemplary only, with a true scope and spirit of the invention being indicated by the following claims.

What is claimed is:

1. A composition for measuring gut transit time, the composition comprising:
a. 3 egg whites from large eggs (100 ml/99 grams) or other equal protein amount
b. ½ teaspoon cream of tartar
c. 1 tablespoon sugar
d. 2 tablespoons jam
e. 2 tablespoons of Gluten-Free Flour or other substitute of equal caloric amount
f. 1½ teaspoons soy, whey or other equal protein
g. 1 teaspoon blue food coloring

2. The composition of claim 1, wherein the jam is a seedless fruit jam.

3. A method for preparing the composition of claim 1, the method comprising pre-heating an oven to 350° F., beating egg whites with cream of tartar and sugar for 1 minute or until soft peaks form; add jam and continue to beat for 30 seconds; add flour 1 tablespoon at a time and beat for a full minute after each addition; add protein powder and beat until incorporated; pouring into oven-safe container; cook 30 minutes or until kitchen thermometer reads 206° F.

4. A method of determining gut transit time, the method comprising feeding a subject the composition of claim 1, and determining when the composition has been eliminated by monitoring the subject's stool until blue color is seen.

5. A kit comprising at least two of the ingredients used to make the composition of claim 1.
